(19) United States
(12) Patent Application Publication
(10) Pub. No.: US 2008/0013076 A1
(43) Pub. Date: Jan. 17, 2008

(54) Surface Inspection Method and Surface Inspection Apparatus

(75) Inventor: Shigeru Matsui, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Tokyo (JP)

(21) Appl. No.: 11/776,887

(22) Filed: Jul. 12, 2007

(30) Foreign Application Priority Data
Jul. 13, 2006 (JP) 2006-193195

(51) Int. Cl. G01N 21/00

(52) U.S. Cl. 356/73

(57) ABSTRACT

It is an object of the present invention to realize a surface inspection method capable of enlarging a dynamic range of a measurement system while keeping high a calculation accuracy for a particle size of a contaminant particle/defect irrespectively of the particle size even if an intensity of a scattered light resulting from the contaminant particle/defect present on a surface of an object to be inspected is dependent on an illumination direction or the like.

A surface of an object to be inspected is illuminated with two illumination beams having an identical wavelength, an identical elevation angle, an identical azimuth, and an identical polarization characteristic but different in intensity by 100:1. Even if an intensity of a scattered light resulting from a contaminant particle/defect present on or near the surface of the object to be inspected has anisotropy dependent on an illumination direction or a detection direction, an intensity ratio of scattered/diffracted/reflected lights generated by illumination beams is always constant to 100:1. It is possible to enlarge a dynamic range of a measurement system while keeping high calculation accuracy for a particle size of the contaminant particle/defect irrespectively of the anisotropy and the particle size of the contaminant particle/defect.

### BACKGROUND OF THE INVENTION

1. Field of the Invention

The present invention relates to a surface inspection method of measuring information on a micro contaminant particle/defect on a semiconductor substrate (semiconductor wafer) and on a surface roughness of the semiconductor substrate.

2. Description of the Related Art

An inspection of a contaminant particle adhering to a surface of a semiconductor substrate or a defect such as a scratch generated during machining is carried out in order to observe dust-generating state in a manufacturing apparatus in a production line for semiconductor substrates (semiconductor wafers).

In relation to a semiconductor substrate prior to formation of a circuit pattern, for example, it is necessary to detect a micro contaminant particle/defect of several tens of nanometers or less on a surface of the semiconductor substrate. Furthermore, the inspection on the surface of the semiconductor substrate is targeted not only at the contaminant particle/defect but also at a crystal defect present in a shallow region near the substrate surface and a surface roughness of the substrate surface.

There is known the following technique as a technique for detecting a micro defect on a surface of an object to be inspected such as a semiconductor substrate, as disclosed in, for example, U.S. Pat. No. 5,798,829. A collected laser light flux is fixedly irradiated onto the surface of the semiconductor substrate, a scattered light from a contaminant particle generated when a contaminant particle adheres onto the semiconductor substrate is detected, and contaminant particles or defects on the entire surface of the semiconductor substrate are inspected.

In such a surface inspection, an intensity of the contaminant particle/defect to be detected is increased generally proportionally to a square or more of a particle size of the contaminant particle/defect. Particularly if the contaminant particle/defect to be detected is sufficiently small as compared with a wavelength of an illumination light and sufficiently small according to Rayleigh scattering rule, it is known that the scattering intensity of the contaminant particle/defect is increased in proportion to the sixth power of the particle size.

Due to this, a wide dynamic range is required for a surface inspection measuring system so as to ensure a wide range of particle sizes measurable in the inspection on the surface of the semiconductor substrate. To meet the requirement, the following methods are also known as techniques for enlarging the dynamic range in the inspection on the surface of the semiconductor substrate.

(1) A technique for illuminating a measurement target substrate with illumination lights at two or more illumination elevation angles so that scattered lights at different intensities are generated even if the illumination lights at the same intensity are irradiated onto the same contaminant particle/defect, and for detecting the scattered lights corresponding to the two or more illumination elevation angles, respectively.

(2) A technique for detecting scattered lights in two or more detection directions (at elevation angles, azimuths or combinations thereof) in which (or at which) the detected scattered lights have different intensities if illumination lights are irradiated onto the same contaminant particle/defect from a predetermined direction.

(3) A technique for arranging two or more photodetectors having different detection sensitivities in predetermined scattering directions if illumination lights are irradiated onto the same contaminant particle/defect from predetermined directions and scattered lights are detected in the predetermined scattering directions.

(4) A technique for variably controlling detection sensitivities of photodetectors arranged in predetermined scattering directions based on intensities of scattered lights being detected if illumination lights are irradiated onto the same contaminant particle/defect from predetermined directions and the scattered lights are detected in the predetermined scattering directions.

The techniques (1) and (2) are disclosed in, for example, Japanese Patent Application Laid-Open No. 2001-235429. The techniques (3) and (4) are disclosed in, for example, U.S. Pat. No. 6,833,913.

Meanwhile, the methods of enlarging the dynamic range according to the above-stated conventional techniques are on the premise that a sensitivity ratio of a sensitivity of a higher sensitivity detection optics to that of a lower sensitivity detection optics is accurately set so as to keep a calculation accuracy high for the particle size of the contaminant particle/defect being detected irrespectively of the particle size.

The conventional techniques (1) and (2) are applicable if a shape of the contaminant particle/defect being detected is isotropic such as a sphere or if the particle size of the contaminant particle/defect being detected is sufficiently small to accord to the Rayleigh scattering rule.

However, if the conventional techniques (1) and (2) are used, it is easily expected that the relation among the intensities of scattered lights corresponding to the different illumination directions or different detection directions is not constant but variable depending on anisotropy if the particle size of the contaminant particle/defect is larger to exceed the range according to the Rayleigh scattering rule and the shape has anisotropy. As a result, it is difficult to accurately set the sensitivity ratio of the sensitivity of the higher sensitivity detection optics to that of the lower sensitivity detection optics.

Particularly if the conventional technique (2) is used, the scattered lights are unavoidably detected only from biased and specific azimuths. If an inspection object moving stage for allowing an object to be inspected to make a rotational movement for a primary scan and to make a translation movement for a secondary scan is employed, the relative relation between the object to be inspected and the detection azimuth changes according to the primary-scan rotational movement. As a result, even if the same contaminant particle/defect is to be detected, the sensitivities of the detection optics disadvantageously and possibly change according to a position at which the contaminant particle/defect adheres onto the surface of the object to be inspected.

Moreover, the conventional technique (3) is free from the disadvantages with which the conventional techniques (1) and (2) are confronted. However, if a detection optics is constituted by a plurality of photodetectors for detecting scattered lights in directions of combinations of a plurality of elevation angles and a plurality of azimuths, it is disadvantageously and greatly difficult to prepare each of the photodetectors configured to include a combination of a high-sensitivity detector and a low-sensitivity detector in view of spatial allocation of the photodetectors. Besides, an increase in the number of photodetectors disadvantageously causes reduction in MTBF (mean time between failures).

If the conventional technique (4) is used, the number of photodetectors does not increase. However, it is expected that to dynamically change sensitivities of the photodetectors during measurement is susceptible to influence of individual difference among transient response characteristics of the photodetectors. Particularly if many photodetectors are employed, it is disadvantageously difficult to keep constant inspection sensitivity characteristic among a plurality of apparatuses of the same model.

### SUMMARY OF THE INVENTION

It is an object of the present invention to provide a surface inspection method and a surface inspection apparatus capable of enlarging a dynamic range of a measurement system while keeping high a calculation accuracy for a particle size of a contaminant particle/defect irrespectively of the particle size even if an intensity of a scattered light resulting from the contaminant particle/defect present on or near a surface of an object to be inspected has anisotropy dependent on an illumination direction or a detection direction.

According to an aspect of the present invention, there is provided a surface inspection method for irradiating an optical beam onto a surface of an object to be inspected mounted on an inspection object moving stage making a rotational movement for a primary scan and a translation movement for a secondary scan, collecting a scattered/diffracted/reflected light from the object to be inspected, and inspecting the surface of the object to be inspected based on the collected scattered/diffracted/reflected light.

The surface inspection method includes: irradiating a first optical beam and a second optical beam having an almost identical elevation angle and an almost identical azimuth with respect to the surface of the object to be inspected, an almost identical polarization characteristic, an almost identical wavelength, and different intensities onto two different illumination regions on the surface of the object to be inspected, respectively; and collecting scattered/diffracted/reflected lights from the two illumination regions, respectively, and detecting a position and a size of a contaminant particle/defect present on or near the surface of the object to be inspected or a surface roughness of the object to be inspected based on the collected scattered/diffracted/reflected lights.

According to an aspect of the present invention, there is provided a surface inspection apparatus, including: an optical beam irradiating unit for irradiating a first optical beam and a second optical beam having an almost identical elevation angle and an almost identical azimuth with respect to the surface of the object to be inspected, an almost identical polarization characteristic, an almost identical wavelength, and different intensities onto two different illumination regions on the surface of the object to be inspected, respectively; a focusing unit for collecting scattered/diffracted/reflected lights from the two illumination regions, respectively; an inspecting unit for detecting a position and a size of a contaminant particle/defect present on or near the surface of the object to be inspected or a surface roughness of the object to be inspected based on the collected scattered/diffracted/reflected lights.

According to the present invention, even if an intensity of a scattered light resulting from a contaminant particle/defect present on or near the surface of the object to be inspected has anisotropy dependent on an illumination direction or a detection direction, it is possible to realize a surface inspection method and a surface inspection apparatus capable of enlarging a dynamic range of a measurement system while keeping high calculation accuracy for a particle size of the contaminant particle/defect irrespectively of the particle size of the contaminant particle/defect.

### BRIEF DESCRIPTION OF THE DRAWINGS

FIG. 1 is an explanatory diagram for explaining a positional relationship between a first illumination region and a second illumination region according to the present invention;

FIG. 2 is a schematic diagram showing a configuration of a contaminant particle/defect inspection apparatus according to the present invention;

FIG. 3 is a plan view of optics according to the first embodiment of the present invention;

FIG. 4 is a side view of the optics according to the first embodiment of the present invention;

FIG. 5 is a diagram showing a relative relation in polarizing direction among illumination optics according to the first embodiment of the present invention;

FIG. 6 is a processing flowchart according to the first embodiment of the present invention;

FIG. 7 is a schematic plan view of detection optics of a contaminant particle/defect inspection apparatus according to a second embodiment of the present invention;

FIG. 8 is a schematic side view of the detection optics of the contaminant particle/defect inspection apparatus according to the second embodiment of the present invention; and

FIG. 9 is a schematic diagram showing a configuration of a signal processing system according to the second embodiment of the present invention.

### DESCRIPTION OF THE PREFERRED EMBODIMENTS

Embodiments of the present invention will be described hereinafter with reference to the accompanying drawings.

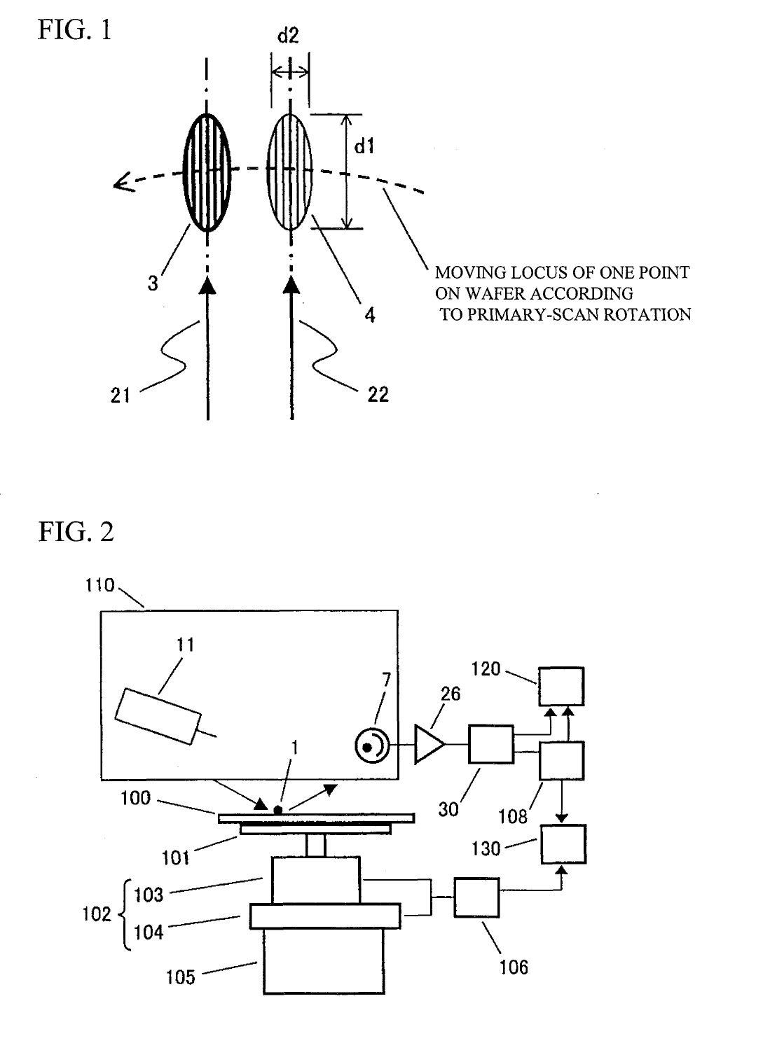

FIG. 1 is an explanatory diagram for explaining the principle of a surface inspection method according to the present invention. FIG. 2 is a schematic diagram showing a configuration of a surface inspection apparatus according to a first embodiment of the present invention.

Referring to FIG. 2, a semiconductor wafer 100, which is an object to be inspected, is vacuum chucked to a chuck 101. The chuck 101 is mounted on an inspection object moving stage 102 that includes a rotation stage 103 and a translation stage 104, and a Z stage 105.

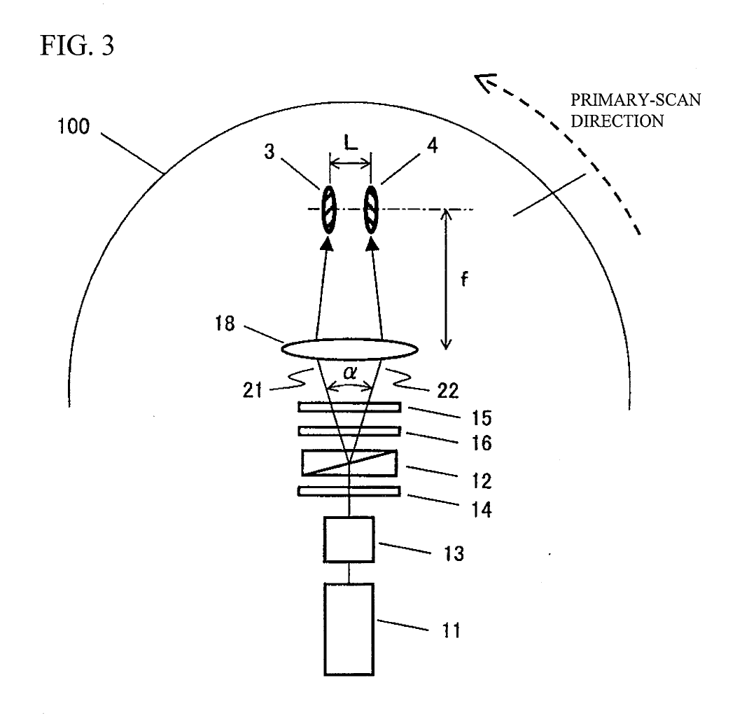

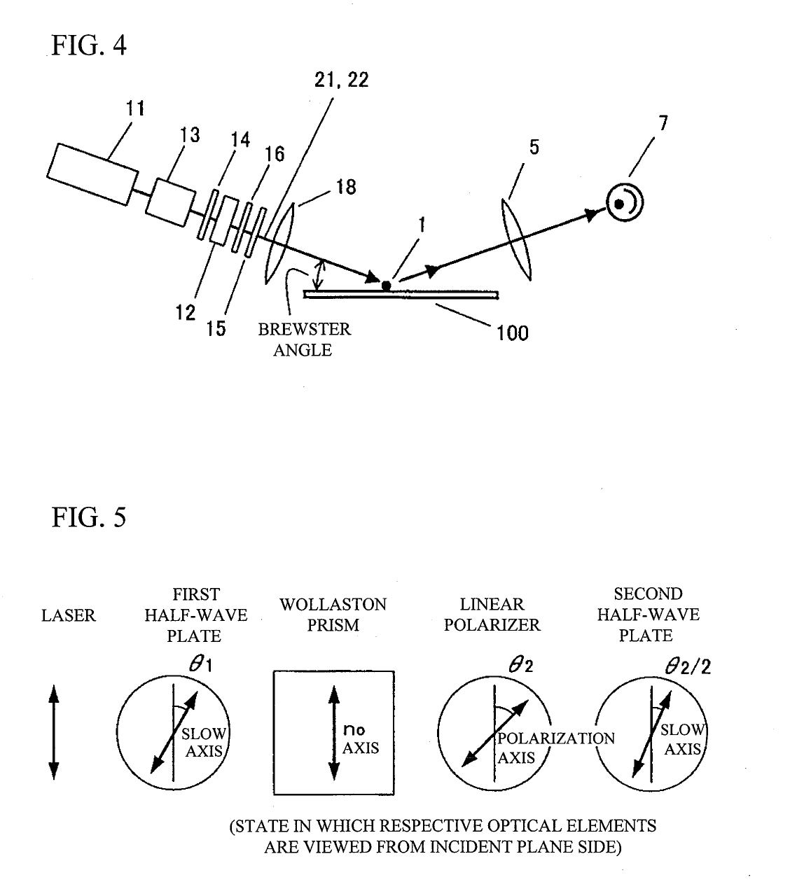

An illumination/detection optics 110 arranged above the semiconductor wafer 100 is an optics shown in FIGS. 3 and 4. FIG. 3 is a plan view of the optics and FIG. 4 is a side view of the optics. Referring to FIGS. 3 and 4, a pulse laser which generates pulse oscillation by temporally repeating an optical beam at a wavelength in a UV region is employed as an illumination light source 11. The optical beam emitted from the light source 11 is adjusted to a parallel light flux having an appropriate beam diameter by a beam expander 13, passed through a first half-wave plate 14, and split into two illumination beams 21 and 22 by a Wollaston prism 12.

The illumination beams 21 and 22 isolated from each other are passed through a linear polarizer 16 and then passed through a second half-wave plate 15. If a plate-like linear polarizer suitable for the UV region is not available, a polarization beam splitter may be employed in place of the linear polarizer. The relative relation among the optical beams emitted from the light source 11, the first half-wave plate 14, the Wollaston prism 12, the linear polarizer 16, and the second half-wave plate 15 in orientation of a polarization axis of each polarizing element is shown in FIG. 5.

In FIG. 5, it is assumed that an oscillating direction of the optical beam emitted from the light source 11 is perpendicular to a horizontal plane of the illumination/detection optics 110 (a plane parallel to a floor surface on which the apparatus is disposed). It is also assumed that a polarization axis of a birefringent crystal located on an incident side in an ordinary ray direction out of two birefringent crystals constituting the Wollaston prism 12 is parallel to the oscillating direction of the optical beam emitted from the light source 11.

Furthermore, it is assumed that an angle of a slow axis of the first half-wave plate 14 is θ1, a polarization axis of the linear polarizer 16 is θ2, and a slow axis of the second half-wave plate 15 is θ2/2 with respect to the oscillating direction of the optical beam emitted from the light source 11.

An intensity ratio R of the illumination beam 21 to the illumination beam 22 on this assumption is represented by the following Equation (1).

R=(sin² θ1·sin² θ2)/(cos² θ1·cos² θ2) (1)

According to the first embodiment of the present invention, the intensity ratio R is assumed to be set to satisfy a condition of R=1/100. The condition of R=1/100 is satisfied when, for example, θ1=θ2=17.55° according to the Equation (1).

As obvious from FIG. 5, the illumination beams 21 and 22 after being passed through the second half-wave plate 15 are identical to oscillating direction, and the both illumination beams 21 and 22 are linearly polarized lights parallel to the oscillating direction of the optical beam emitted from the light source 11. After being passed through the second half-wave plate 15, the illumination beam 21 forms a first illumination spot 3, shown in FIG. 1, by an action of an illumination lens 18. Likewise, after being passed through the second half-wave plate 15, the illumination beam 22 forms a second illumination spot 4, shown in FIG. 1, by the action of the illumination lens 18. In this manner, the first and second illumination spots 3 and 4 are obliquely illuminated by p-polarization, respectively.

To detect a micro contaminant particle/defect with high sensitivity, an elevation angle of an illumination beam with respect to the surface of the object to be inspected is preferably as low as about 5° to 45°, more preferably near a Brewster angle with respect to a constituent material of the object to be inspected.

According to the first embodiment of the present invention, therefore, the surface inspection apparatus is configured to cause the illumination beams 21 and 22 to be obliquely incident on a surface of the semiconductor wafer 100 in a direction generally from an inner circumference to an outer circumference of the semiconductor wafer 100 at the Brewster angle with respect to a crystal Si. Due to this, the illumination spots 3 and 4 are generally ellipsoidal.

It is defined anew herein that an interior of a border line an illuminance of which is reduced to one to a square of ‘e’ of a central portion of an illumination spot (where e indicates a base of a natural logarithm) is an illumination spot. As shown in FIG. 1, a width of each of the illumination spots 3 and 4 in a major-axis direction is d1 and that in a minor-axis direction is d2. The illumination spots 3 and 4 have almost identical widths d1 and d2 in the major-axis direction and the minor-axis direction. The illumination spots 3 and 4 are illuminated by illumination light fluxes having an identical elevation angle, an identical azimuth, an identical polarization characteristic, and an identical wavelength with respect to the surface of the semiconductor wafer 100. Illuminances of the respective illumination beams 21 and 22 are adjusted to satisfy a ratio of 100:1.

Further, as shown in FIG. 1, the illumination spots 3 and 4 are illuminated so as not to be overlapped in a primary-scan direction of the inspection object moving stage 102. A locus of the illumination spot 3 on the surface of the semiconductor wafer 100 according to a primary-scan rotation of the inspection object moving stage 102 is generally overlapped with that of the illumination spot 4 in a radial direction of the inspection object moving stage 102.

Moreover, the illumination spots 3 and 4 are arranged in an order in which one point on the semiconductor wafer 100 is passed through the second illumination spot 4 and then passed through the first illumination spot 3 according to the primary-scan rotation.

In this case, if a separation angle at which the Wollaston prism 12 isolates the illumination beams 21 and 22 from each other is A and a focal length of the illumination lens 18 is f, a length L between the illumination spots 3 and 4 is represented by the following Equation (2).

L≅f·tan A (2)

According to the first embodiment of the present invention, the length L is set to 200 micrometers (L=200 μm). If a lens having a focal length f of 200 millimeters (f=200 mm) is employed as the illumination lens 18, the separation angle A at which the Wollaston prism 12 isolates the illumination spots 3 and 4 from each other is approximately 3.4 arc-minutes (A≅3.4 arc-minutes).

It is also preferable that the length L is small while ensuring a length at which an amplifier 26 can appropriately isolate and detect two signal peaks deriving from the two illumination spots 3 and 4.

A condenser lens 5 is configured to be able to focus a scattered/diffracted/reflected light from a micro contaminant particle/defect 1 at a low elevation angle so that the condenser lens 5 can efficiently capture the scattered light according to Rayleigh scattering. The scattered/diffracted/reflected light collected by the condenser lens 5 is converted into a scattered/diffracted/reflected light signal by a photodetector 7. In the first embodiment of the present invention, a photomultiplier tube is employed as the photodetector 7. Alternatively, any other photodetector on detection principle may be employed as long as it can detect a scattered/diffracted/reflected light from the micro contaminant particle/defect 1 with high sensitivity.

With the above-stated configuration, the contaminant particle/defect 1 is passed through the second illumination spot 4 (at the illuminance one-hundredth of that of the illumination spot 3) and then passed through the first illumination spot 3. Therefore, scattered/diffracted/reflected light signals corresponding to the respective illumination spots 3 and 4 can be obtained by the photodetector 7. The scattered/diffracted/reflected light signals are transmitted from the photodetector 7 to the amplifier 26, and amplified by the amplifier 26. Thereafter, the amplified scattered/diffracted/reflected light signals are sampled at every sampling interval dT and converted into digital data by an analog-to-digital (A/D) converter 30.

The sampling interval dT is set to be sufficiently narrower than a time interval until the contaminant particle/defect 1 is passed through the illumination spot 4 and then the illumination spot 3. A contaminant particle/defect determination mechanism 108 compares the digital data at every sampling interval dT with a preset detection lower threshold. If the digital data is equal to or greater than the detection lower threshold, the contaminant particle/defect determination mechanism 108 determines that this digital data results from the contaminant particle/defect 1 and generates contaminant particle/defect determination information.

As stated, the illuminance of the second illumination spot 4 is set to the one-hundredth of that of the first illumination spot 3. Due to this, the following three cases may be considered depending on at what efficiency the scattered/diffracted/reflected lights are generated from the contaminant particle/defect 1.

(1) A case in which both the scattered/diffracted/reflected light signal corresponding to the illumination spot 3 and the scattered/diffracted/reflected light signal corresponding to the illumination spot 4 exceed the detection lower threshold.

(2) A case in which the scattered/diffracted/reflected light signal corresponding to the illumination spot 3 exceeds the detection lower threshold but the scattered/diffracted/reflected light signal corresponding to the illumination spot 4 does not exceed the detection lower threshold.

(3) A case in which neither the scattered/diffracted/reflected light signal corresponding to the illumination spot 3 nor the scattered/diffracted/reflected light signal corresponding to the illumination spot 4 exceed the detection lower threshold.

The following abnormal case (4) may be occurred due to undesirable disturbance factor.

(4) A case in which the scattered/diffracted/reflected light signal corresponding to the illumination spot 3 does not exceed the detection lower threshold but the scattered/diffracted/reflected light signal corresponding to the illumination spot 4 exceeds the detection lower threshold.

The case (4) is an abnormal case and its incidence probability is considered to be quite low. Due to this, the case (4) is ignorable. Further, there is no need to consider the case (3) in which the scattered/diffracted/reflected light signals corresponding to the respective illumination spots 3 and 4 do not exceed the detection lower threshold. Therefore, only the cases (1) and (2) are considered.

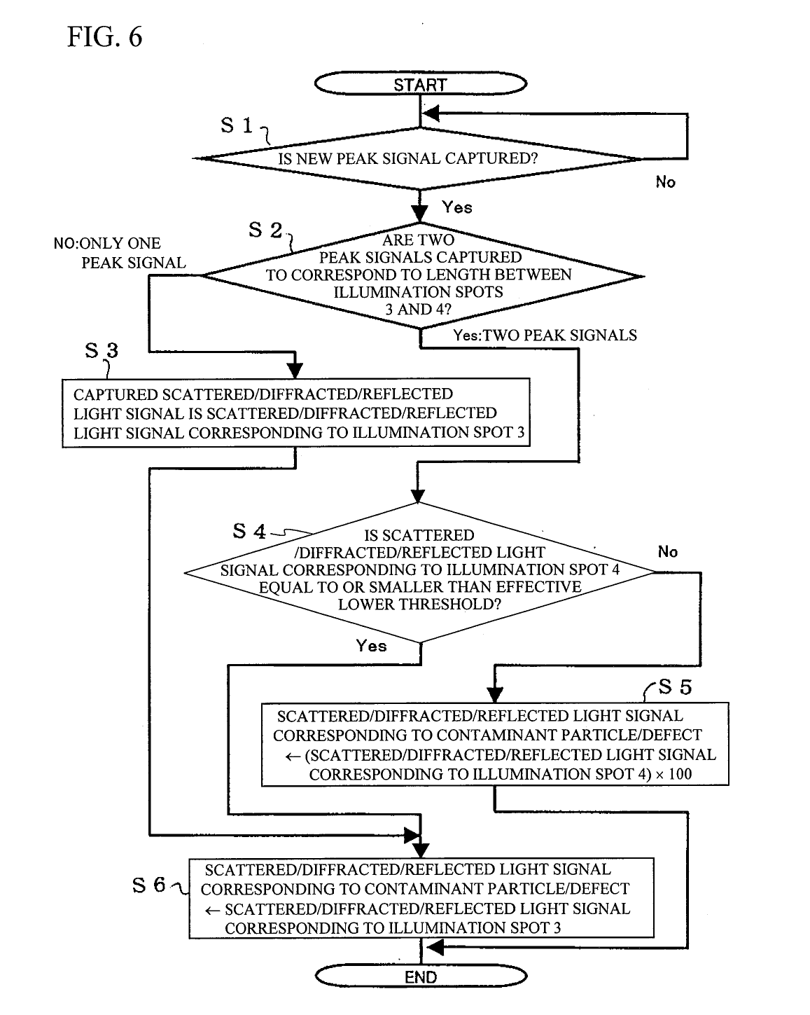

FIG. 6 is a flowchart for processing the scattered/diffracted/reflected light signals according to the first embodiment of the present invention.

Referring to FIG. 6, it is determined whether a new peak signal is captured (step S1). If it is determined at the step S1 that the new peak signal is captured, it is then determined whether two peaks corresponding to the respective illumination spots 3 and 4 are captured, that is, scattering or the like from the same contaminant particle or the like is detected to correspond to the respective illumination spots 3 and 4 (step S2).

In the case (1), the processing goes to a step S4, at which it is determined whether the scattered/diffracted/reflected light signal corresponding to the illumination spot 4 is equal to or smaller than an effective lower threshold. The effective lower threshold is set to prevent a quantization error from becoming greater during conversion into the particle size when an effective number of the converted digital value is too small.

In the comparison determination at the step S4, if the scattered/diffracted/reflected light signal corresponding to the illumination spot 4 is equal to or smaller than the effective lower threshold, the scattered/diffracted/reflected light signal corresponding to the illumination spot 3 is adopted as a scattered/diffracted/reflected light signal corresponding to the contaminant particle/defect 1 (step S6).

On the other hand, in the comparison determination at the step S4, if the scattered/diffracted/reflected light signal corresponding to the illumination spot 4 exceeds the effective lower threshold, a value obtained by multiplying the scattered/diffracted/reflected light signal corresponding to the illumination spot 4 by 100 (a magnification of the intensity of the first optical beam 21 relative to that of the second optical beam 22) is adopted as the scattered/diffracted/reflected light signal corresponding to the contaminant particle/defect 1 (step S5).

If it is determined at the step S2 that the number of captured peak signals is one, i.e., in the case (2), the scattered/diffracted/reflected light signal corresponding to the illumination spot 3 is adopted as the scattered/diffracted/reflected light signal corresponding to the contaminant particle/defect 1 (steps S3 and S6).

As a result of the above-stated processing, the effect of enlarging the dynamic range by at least 100 times can be obtained. The determination as to whether a contaminant particle/defect is present based on the effective lower threshold may be made by comparing an output electric signal from the amplifier 26 with the preset effective lower threshold instead of comparing the digital data obtained from the A/D converter 30 with the preset lower threshold.

A particle size calculation mechanism 120 calculates a size of the detected contaminant particle/defect from the scattered/diffracted/reflected light signal corresponding to the contaminant particle/defect 1.

If the contaminant particle/defect determination mechanism 108 generates the contaminant particle/defect determination information, a contaminant particle/defect coordinate detection mechanism 130 calculates a coordinate position (r, 0) of the contaminant particle/defect 1 in the primary-scan direction and the secondary-scan direction from present position information on the primary scan and the secondary scan generated from the inspection object moving stage 102.

The contaminant particle/defect coordinate detection mechanism 130 corrects a coordinate θ out of the coordinate position (r, θ) based by determining which digital data is adopted as the scattered/diffracted/reflected light signal corresponding to the contaminant particle/defect 1, whether the digital data on the scattered/diffracted/reflected light signal generated to correspond to the illumination spot 3 or the digital data on the scattered/diffracted/reflected light signal generated to correspond to the illumination spot 4.

Specifically, if a certain contaminant particle/defect is detected on the illumination spot 3, the semiconductor wafer 100 advances by 200 micrometers (corresponding to the length between the illumination spots 3 and 4) in the primary-scan direction as compared with the instance in which the same contaminant particle/defect is detected on the illumination spot 4. Therefore, the contaminant particle/defect coordinate detection mechanism 130 corrects the coordinate θ by as much as this advancement amount.

As stated so far, according to the first embodiment of the present invention, the two illumination beams 21 and 22 having the identical wavelength, the identical elevation angle, the identical azimuth, and the identical polarization characteristic but different in intensity by the intensity ratio of 100:1 illuminate the surface of the object to be inspected. Therefore, even if the intensity of the scattered light resulting from the contaminant particle/defect 1 present on or near the surface of the semiconductor wafer 100 has anisotropy dependent on the illumination direction or the detection direction, the intensity ratio of the scattered/diffracted/reflected lights generated by the respective illumination beams 21 and 22 is always constant to 100:1. It is, therefore, advantageously possible to enlarge the dynamic range of the measurement system while keeping high the calculation accuracy for the particle size of the contaminant particle/defect 1 irrespectively of the anisotropy and the particle size of the contaminant particle/defect 1.

In the first embodiment of the present invention, the “pulse laser which generates pulse oscillation by temporally repeating an optical beam at the wavelength in the UV region” is employed as the light source 11. However, even if a “laser at a wavelength in a region other than the UV region” or a “laser which generates continuous oscillation” is employed as the light source 11, the technique according to the first embodiment is applicable.

Moreover, in the first embodiment of the present invention, the direction in which each of the two illumination beams 21 and 22 illuminates the surface of the semiconductor wafer 100 is set to the “direction generally from the inner circumference to the outer circumference of the semiconductor wafer 100”. However, even if the direction is a “direction generally from the outer circumference to the inner circumference of the semiconductor wafer 100”, the technique according to the first embodiment is applicable. Generally, the phenomenon that the position of an illumination spot changes occurs to the oblique illumination when the height relationship between an illumination beam and the surface of an object to be illuminated changes. Nevertheless, by setting each of the irradiation directions of the two illumination beams to the “direction generally from the outer circumference to the inner circumference of the semiconductor wafer 100” or the “direction generally from the inner circumference to the outer circumference of the semiconductor wafer 100”, the two illumination spots 3 and 4 move on the surface of the semiconductor wafer 100 in the same direction r by the same length. It is, therefore, advantageously possible to keep the relation that the “locus of the illumination spot 3 on the surface of the semiconductor wafer 100 according to the primary-scan rotation of the inspection object moving stage 102 is generally overlapped with that of the illumination spot 4 in the radial direction of the inspection object moving stage 102” without disturbing it.

Furthermore, in the first embodiment of the present invention, the polarized states of the illumination beams 21 and 22 when illuminating the first and second illumination spots 3 and 4, respectively are both “p-polarized lights”. However, even if a polarization controller 111 is arranged on an optical path of each of the illumination beams 21 and 22 to control the illumination beams 21 and 22 to be converted into “s-polarized lights”, “circularly polarized lights” or “elliptically polarized lights almost identical in ellipticity” before the illumination beams 21 and 22 are incident on the illumination spots 3 and 4, respectively, the advantages of the first embodiment can be exhibited.

Further, in the first embodiment of the present invention, the determination as to which scattered/diffracted/reflected light signal is adopted as the scattered/diffracted/reflected light corresponding to the contaminant particle/defect 1, the scattered/diffracted/reflected light signal corresponding to the first illumination spot 3 or that corresponding to the second illumination spot 4 is made by determining “whether the scattered/diffracted/reflected light signal corresponding to the second illumination spot 4 is equal to or smaller than the effective lower threshold”. Alternatively, the determination may be made by determining “whether the scattered/diffracted/reflected light signal corresponding to the illumination spot 3 exceeds a detection upper threshold”.

The reason is as follows. In an ordinary photodetector, particularly the photomultiplier tube suited for the constitution of the present invention, it is known that if an output of the detector increases to be equal to or greater than a certain threshold, the linearity between an amount of the incident light and an amount of the output electric signal begins to be destroyed. If the amount of the incident light further increases, the output electric signal saturates. Due to this, the detection upper threshold is set to always employ the photodetector 7 below a range in which the linearity between the amount of the incident light and the amount of the output electric signal begins to be destroyed. In this alternative comparison determination, if the scattered/diffracted/reflected light signal corresponding to the illumination spot 3 does not exceed the detection upper threshold, the scattered/diffracted/reflected light signal corresponding to the illumination spot 3 is adopted as the scattered/diffracted/reflected light signal corresponding to the contaminant particle/defect 1.

On the other hand, if the scattered/diffracted/reflected light signal corresponding to the illumination spot 3 exceeds the detection upper threshold, a value obtained by multiplying the scattered/diffracted/reflected light signal corresponding to the illumination spot 4 by 100 is adopted as the scattered/diffracted/reflected light signal corresponding to the contaminant particle/defect 1.

The alternative determination as to whether a contaminant particle/defect is present based on the detection upper threshold may be made by comparing an output electric signal from the amplifier 26 with the detection upper threshold instead of comparing the digital data obtained from the A/D converter 30 with the detection upper threshold.

In the first embodiment of the present invention, one detection direction is used for detecting the scattered/diffracted/reflected lights. Alternatively, the surface inspection apparatus may be configured so that detection optics are arranged in a plurality of directions corresponding to combinations of a plurality of elevation angles and a plurality of azimuths, respectively, and so as to detect the scattered/diffracted/reflected lights from the respective directions.

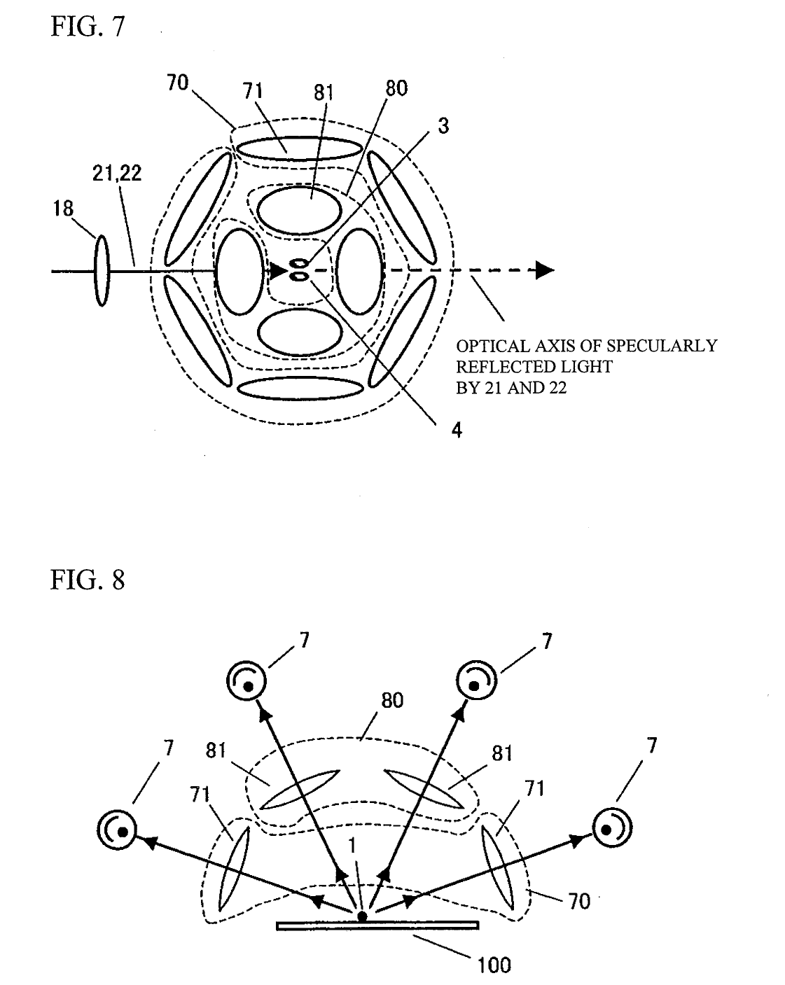

FIGS. 7 and 8 are explanatory diagrams of a second embodiment of the present invention. In the second embodiment of the present invention, the detection optics according to the first embodiment is arranged in each of a plurality of directions according to combinations of a plurality of elevation angles and a plurality of azimuths. Further, scattered/diffracted/reflected lights are detected from the respective directions.

FIG. 7 is a plan view of the detection optics and FIG. 8 is a side view of the detection optics.

Since illumination optics according to the second embodiment are the same as those according to the first embodiment, they will not be described in detail.

The scattered/diffracted/reflected light detection optics according to the second embodiment of the present invention is configured to include a first elevation angle detection optics 70 and a second elevation angle detection optics 80. The first elevation angle detection optics 70 includes six focusing elements 71 having an almost identical first elevation angle, and detecting scattered/diffracted/reflected lights from six azimuths different from one another with respect to a primary-scan rotational axis of an inspection object moving stage 102 and staggered by about 60° from one another, respectively. The second elevation angle detection optics 80 includes four focusing elements 81 having an almost identical second elevation angle higher than the first elevation angle, and detecting scattered/diffracted/reflected lights from four azimuths different from one another with respect to the primary-scan rotational axis of the inspection object moving stage 102 and staggered by about 90° from one another, respectively.

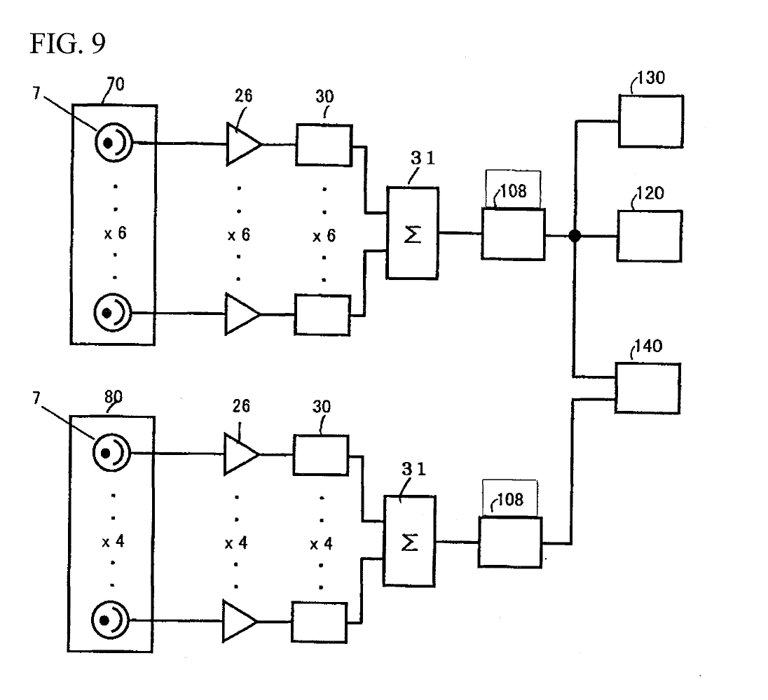

Each of the ten focusing elements 71 and 81 is constituted by a lens. As shown in FIG. 9, scattered/diffracted/reflected lights collected by the respective focusing elements 71 and 81 and resulting from a first illumination spot 3 and a second illumination spot 4 are converted into scattered/diffracted/reflected light signals by ten photodetectors 7 corresponding to the respective focusing elements 71 and 81. The scattered/diffracted/reflected light are amplified by ten amplifiers 26, which are provided to correspond to the focusing elements 71 and 81, respectively. Further, the amplified scattered/diffracted/reflected light are sampled at each preset sampling interval dT and converted into digital data by ten A/D converters 30 provided to correspond to the focusing elements 71 and 81, respectively.

Since the condition which the sampling interval dT is to satisfy according to the second embodiment is the same as that according to the first embodiment, it will not be described herein. In the second embodiment, even if a contaminant particle/defect to be detected has anisotropy, an adder 31 adds up all the scattered/diffracted/reflected light signals obtained from the six photodetectors 7 corresponding to the first elevation angle to deal with an addition result as a first combined scattered/diffracted/reflected light signal in order to maintain detection sensitivity as constant as possible.

Likewise, an adder 31 adds up all the scattered/diffracted/reflected light signals obtained from the four photodetectors 7 corresponding to the second elevation angle to deal with an addition result as a second combined scattered/diffracted/reflected light signal.

The first combined scattered/diffracted/reflected light signal and the second combined scattered/diffracted/reflected light signal are transmitted to corresponding contaminant particle/defect determination mechanisms 108, respectively. The two contaminant particle/defect determination mechanisms 108 function similarly to the contaminant particle/defect determination mechanism 108 according to the first embodiment. Namely, each of the contaminant particle/defect determination mechanisms 108 generates a scattered/diffracted/reflected light signal corresponding to a contaminant particle/defect 1 from the scattered/diffracted/reflected light signals deriving from the respective illumination spots 3 and 4.

The surface inspection apparatus according to the second embodiment of the present invention includes one particle size calculation mechanism 120. The particle size calculation mechanism 120 calculates a size of the detected contaminant particle/defect 1 from the first combined scattered/diffracted/reflected light signal corresponding to the contaminant particle/defect 1. Since a contaminant particle/defect coordinate detection mechanism 130 according to the second embodiment functions similarly to that according to the first embodiment, it will not be described herein.

In the second embodiment of the present invention, two scattered/diffracted/reflected light signals measured at the two different elevation angles with respect to one contaminant particle/defect 1 are obtained. Therefore, a contaminant particle/defect classification mechanism 140 compares the first and second scattered/diffracted/reflected light signals with each other, thereby determining and classifying a type of the detected contaminant particle/defect 1, e.g., determining whether the detected contaminant particle/defect 1 is a contaminant particle adhering to a surface of a semiconductor wafer 100 or a crystal defect within the semiconductor wafer 100.

In the second embodiment of the present invention, similarly to the first embodiment, two illumination beams having an identical wavelength, an identical elevation angle, an identical azimuth, and an identical polarization characteristic but different in intensity by an intensity ratio of 100:1 illuminate the surface of the object to be inspected, i.e., semiconductor wafer 100.

Therefore, even if intensities of the scattered lights resulting from the contaminant particle/defect 1 present on or near the surface of the semiconductor wafer 100 have anisotropy dependent on the illumination directions or the detection directions, the intensity ratio of the scattered/diffracted/reflected lights generated by the respective illumination beams 21 and 22 is always constant to 100:1. It is, therefore, advantageously possible to enlarge the dynamic range of the measurement system while keeping high the calculation accuracy for the particle size of the contaminant particle/defect 1 irrespectively of the anisotropy and the particle size of the contaminant particle/defect 1.

Moreover, there is no need to increase the number of a plurality of photodetectors 7 arranged in the respective detection directions. It is, therefore, advantageously possible to enlarge the dynamic range without causing a problem related to the spatial allocation of optical elements.

Furthermore, since driving conditions, e.g., applied voltages for the respective photodetectors 7 are not switched during measurements, a stable output signal can be obtained.

In the second embodiment, “the adder 31 adds up all the scattered/diffracted/reflected light signals obtained from the six photodetectors 7 corresponding to the first elevation angle to deal with the addition result as the first combined scattered/diffracted/reflected light signal”. In addition, “the adder 31 adds up all the scattered/diffracted/reflected light signals obtained from the four photodetectors 7 corresponding to the second elevation angle to deal with the addition result as the second combined scattered/diffracted/reflected light signal”. The “contaminant particle/defect classification mechanism 140 compares the first and second scattered/diffracted/reflected light signals with each other, thereby determining and classifying the type of the detected contaminant particle/defect 1, e.g., determining whether the detected contaminant particle/defect 1 is a contaminant particle adhering to a surface of a semiconductor wafer 100 or a crystal defect within the semiconductor wafer 100”. Alternatively, the determination and classification may be made by the other method.

For example, the detected contaminant particle/defect 1 may be determined not by comparing the results of adding up the signals from all the photodetectors corresponding to the respective elevation angles with each other but by individually using scattered/diffracted/reflected light signals obtained from the photodetectors corresponding to the respective elevation angles.

By causing the contaminant particle/defect classification mechanism 140 to perform the above-stated processing, it is possible to determine, for example, whether a shape of the detected contaminant particle/defect 1 has anisotropy. Needless to say, even if the processing performed by the contaminant particle/defect classification mechanism 140 is thus changed, the advantages of the present invention remain unchanged as long as the processing performed by the particle size calculation mechanism 120 related to the dynamic range is not changed.

As stated so far, according to the present invention, even if the intensity of the scattered light resulting from the contaminant particle/defect present on or near the surface of the semiconductor wafer has anisotropy dependent on the illumination direction or the detection direction, it is possible to enlarge the dynamic range of the measurement system while keeping high the calculation accuracy for the particle size of the contaminant particle/defect irrespectively of the anisotropy and the particle size of the contaminant particle/defect.

Particularly by using the surface inspection technique for detecting the scattered lights in a plurality of directions according to combinations of a plurality of elevation angles and a plurality of azimuths, even if the intensities of the scattered lights resulting from the contaminant particle/defect present on or near the surface of the semiconductor wafer have anisotropy dependent on the illumination directions or the detection directions, it is possible to enlarge the dynamic range of the measurement system while keeping high the calculation accuracy for the particle size of the contaminant particle/defect irrespectively of the anisotropy and the particle size of the contaminant particle/defect.

What is claimed is:

1. A surface inspection method for irradiating an optical beam onto a surface of an object to be inspected mounted on an inspection object moving stage making a rotational movement for a primary scan and a translation movement for a secondary scan, collecting a scattered/diffracted/reflected light from the object to be inspected, and inspecting the surface of the object to be inspected based on the collected scattered/diffracted/reflected light, comprising:
irradiating a first optical beam and a second optical beam onto two different illumination regions on the surface of the object to be inspected, respectively, said first and second optical beams having an almost identical elevation angle and an almost identical azimuth with respect to the surface of the object to be inspected, an almost identical polarization characteristic, an almost identical wavelength, and different intensities; and
collecting scattered/diffracted/reflected lights from the two illumination regions, respectively, and detecting a position and a size of a contaminant particle/defect present on or near the surface of the object to be inspected or a surface roughness of the object to be inspected based on the collected scattered/diffracted/reflected lights.

2. The surface inspection method according to claim 1,
wherein the first optical beam and the second optical beam are obtained by splitting an optical beam generated from one light source.

3. The surface inspection method according to claim 2,
wherein both the first optical beam and the second optical beam are p-polarized lights, s-polarized lights, circularly polarized lights, or elliptically polarized lights almost identical in ellipticity.

4. The surface inspection method according to claim 2,
wherein the intensity of the second optical beam is 1/10 to 1/100 of the intensity of the first optical beam.

5. The surface inspection method according to claim 2,
wherein the elevation angle of each of the first optical beam and the second optical beam with respect to the surface of the object to be inspected is within a range of 5° to 45°.

6. The surface inspection method according to claim 5,
wherein the elevation angle of each of the first optical beam and the second optical beam with respect to the surface of the object to be inspected is almost a Brewster angle with respect to an optical constant of a main constituent matter of the object to be inspected.

7. The surface inspection method according to claim 1,
wherein a locus of the second illumination region on the surface of the object to be inspected, the second illumination region being irradiated by the second optical beam according to a primary-scan rotation of the inspection object moving stage, is overlapped almost coincidentally with a locus of the first illumination region on the surface of the object to be inspected, the first illumination region being irradiated by the first optical beam according to the primary-scan rotation of the inspection object moving stage, in a radial direction of the inspection object moving stage.

8. The surface inspection method according to claim 7,
wherein one point on the surface of the object to be inspected is passed through the second illumination region and then the first illumination region according to the primary-scan rotation of the inspection object moving stage.

9. The surface inspection method according to claim 7,
wherein the first optical beam and the second optical beam are obtained by splitting an optical beam generated from one continuously oscillating laser light source.

10. The surface inspection method according to claim 7,
wherein if only a peak signal corresponding to the scattered/diffracted/reflected light from the first illumination region is obtained, the position and the size of the contaminant particle/defect or the surface roughness of the contaminant particle/defect is detected based on the peak signal obtained from the first illumination region,
if two peak signals corresponding to the scattered/diffracted/reflected lights from the first illumination region and the second illumination region are obtained, respectively, and if the peak signal obtained from the second illumination region is equal to or smaller than an effective lower threshold, the position and the size of the contaminant particle/defect or the surface roughness of the contaminant particle/defect is detected based on the peak signal obtained from the first illumination region, and
if the two peak signals corresponding to the scattered/diffracted/reflected lights from the first illumination region and the second illumination region are obtained, respectively, and if the peak signal obtained from the second illumination region exceeds the effective lower threshold, the position and the size of the contaminant particle/defect or the surface roughness of the contaminant particle/defect is detected based on a signal obtained by multiplying the peak signal obtained from the second illumination region by a magnification indicating the intensity of the first optical beam relative to the intensity of the second optical beam.

11. A surface inspection apparatus for irradiating an optical beam onto a surface of an object to be inspected mounted on an inspection object moving stage making a rotational movement for a primary scan and a translation movement for a secondary scan, collecting a scattered/diffracted/reflected light from the object to be inspected, and inspecting the surface of the object to be inspected based on the collected scattered/diffracted/reflected light, comprising:
an optical beam irradiating unit for irradiating a first optical beam and a second optical beam onto two different illumination regions on the surface of the object to be inspected, respectively, said first and second optical beams having an almost identical elevation angle and an almost identical azimuth with respect to the surface of the object to be inspected, an almost identical polarization characteristic, an almost identical wavelength, and different intensities;
a focusing unit for collecting scattered/diffracted/reflected lights from the two illumination regions, respectively; and
an inspecting unit for detecting a position and a size of a contaminant particle/defect present on or near the surface of the object to be inspected or a surface roughness of the object to be inspected based on the collected scattered/diffracted/reflected lights.

12. The surface inspection apparatus according to claim 11,
wherein the optical beam irradiating unit includes
one light source; and
a unit for splitting an optical beam generated from the light source into the first optical beam and the second optical beam.

13. The surface inspection apparatus according to claim 12,
further comprising a polarizing unit for polarizing both the first optical beam and the second optical beam into p-polarized lights, s-polarized lights, circularly polarized lights, or elliptically polarized lights almost identical in ellipticity.

14. The surface inspection apparatus according to claim 12,
wherein the intensity of the second optical beam is 1/10 to 1/100 of the intensity of the first optical beam.

15. The surface inspection apparatus according to claim 12,
wherein the elevation angle of each of the first optical beam and the second optical beam with respect to the surface of the object to be inspected is within a range of 5° to 45°.

16. The surface inspection apparatus according to claim 15,
wherein the elevation angle of each of the first optical beam and the second optical beam with respect to the surface of the object to be inspected is almost a Brewster angle with respect to an optical constant of a main constituent matter of the object to be inspected.

17. The surface inspection apparatus according to claim 11,
wherein a locus of the second illumination region on the surface of the object to be inspected, the second illumination region being irradiated by the second optical beam according to a primary-scan rotation of the inspection object moving stage, is overlapped almost coincidentally with a locus of the first illumination region on the surface of the object to be inspected, the first illumination region being irradiated by the first optical beam according to the primary-scan rotation of the inspection object moving stage, in a radial direction of the inspection object moving stage.

18. The surface inspection apparatus according to claim 17,
wherein one point on the surface of the object to be inspected is passed through the second illumination region and then the first illumination region according to the primary-scan rotation of the inspection object moving stage.

19. The surface inspection apparatus according to claim 17,
wherein the first optical beam and the second optical beam are obtained by splitting an optical beam generated from one continuously oscillating laser light source.

20. The surface inspection apparatus according to claim 7,
wherein if only a peak signal corresponding to the scattered/diffracted/reflected light from the first illumination region is obtained, the inspecting unit detects the position and the size of the contaminant particle/defect or the surface roughness of the contaminant particle/defect based on the peak signal obtained from the first illumination region,
if two peak signals corresponding to the scattered/diffracted/reflected lights from the first illumination region and the second illumination region are obtained, respectively, and if the peak signal obtained from the second illumination region is equal to or smaller than an effective lower threshold, the inspecting unit detects the position and the size of the contaminant particle/defect or the surface roughness of the contaminant particle/defect based on the peak signal obtained from the first illumination region, and
if the two peak signals corresponding to the scattered/diffracted/reflected lights from the first illumination region and the second illumination region are obtained, respectively, and if the peak signal obtained from the second illumination region exceeds the effective lower threshold, the inspecting unit detects the position and the size of the contaminant particle/defect or the surface roughness of the contaminant particle/defect based on a signal obtained by multiplying the peak signal obtained from the second illumination region by a magnification indicating the intensity of the first optical beam relative to the intensity of the second optical beam.
